(19) United States
(12) Patent Application Publication
(10) Pub. No.: US 2021/0370957 A1
(43) Pub. Date: Dec. 2, 2021

(54) METHOD, APPARATUS, AND SYSTEM FOR DETERMINING VEHICLE INFORMATION BASED ON INERTIAL MEASUREMENT UNIT SENSOR DATA

(71) Applicant: HERE Global B.V., Eindhoven (NL)

(72) Inventors: Silviu ZILBERMAN, Rishon Le-Zion (IL); Harel PRIMACK, Le-Zion (IL)

(21) Appl. No.: 16/884,955

(22) Filed: May 27, 2020

(51) Int. Cl. B60W 40/105

(52) U.S. Cl. CPC B60W 40/105; B60W 2520/28; B60W 2420/503

(57) ABSTRACT

An approach is provided for determining vehicle speed. The approach, for example, involves determining sensor data from a magnetometer, an accelerometer, or a combination thereof associated with a vehicle. The approach also involves processing the sensor data to determine a rotational frequency of at least one tire of the vehicle. The approach further involves calculating a speed, a tire/wheel diameter, a safety condition, and/or a maintenance condition of the vehicle based on the rotational frequency and providing the speed, the tire/wheel diameter, the safety condition, and/or the maintenance condition as an output.

### BACKGROUND

Many mapping, navigation, and/or other location-based services rely on knowing the speed or velocity of a vehicle. Generally, speed can be measured by or inferred from using Global Positioning System (GPS) data or other equivalent positioning technologies (e.g., other Global Navigation Satellite Systems—GNSS), location technologies such as cellular or Wi-Fi triangulation, and/or by using dedicated speed sensors. However, satellite-based positioning may become unavailable because of signal interference, loss of line-of-sight to orbiting satellites, etc., triangulation methods are generally inaccurate, and dedicated speed sensors may not be available or accessible to portable or mobile devices that execute applications to provide such mapping, navigation, and/or other location-based services. As a result, service providers face significant technical challenges to determine the speed or velocity of a vehicle when traditional speed sensors (e.g., GPS or dedicated speed sensors) are not available.

### SOME EXAMPLE EMBODIMENTS

Therefore, there is a need for an approach for determining vehicle speed and/or other vehicle information using alternative sensor technologies, such as ones that are commonly present, but not limited to, cellular phones.

According to one embodiment, a method comprises determining, by a processor, sensor data from a magnetometer, an accelerometer, or a combination (e.g., via using an inertial measurement unit—IMU) thereof associated with a vehicle (e.g., associated directly with the vehicle or with a mobile device co-located with the vehicle). The method also comprises processing, by the processor, the sensor data to determine a rotational frequency of at least one tire of the vehicle. The method further comprises calculating, by the processor, a speed, a tire/wheel diameter, a safety condition, and/or a maintenance condition of the vehicle based on the rotational frequency. The method further comprises providing, by the processor, the speed, the tire/wheel diameter, the safety condition, and/or the maintenance condition as an output.

According to another embodiment, an apparatus comprises at least one processor, and at least one memory including computer program code for one or more computer programs, the at least one memory and the computer program code configured to, with the at least one processor, cause, at least in part, the apparatus to determine sensor data from a magnetometer, an accelerometer, or a combination (e.g., via an inertial measurement unit—IMU) thereof associated with a vehicle (e.g., associated directly with the vehicle or with a mobile device co-located with the vehicle). The apparatus is also caused to process the sensor data to determine a rotational frequency of at least one tire of the vehicle. The apparatus is further caused to calculate a speed, a tire/wheel diameter, a safety condition, and/or a maintenance condition of the vehicle based on the rotational frequency. The apparatus is further caused to provide the speed, the tire/wheel diameter, the safety condition, and/or the maintenance condition as an output.

According to another embodiment, a computer-readable storage medium carries one or more sequences of one or more instructions which, when executed by one or more processors, cause, at least in part, an apparatus to determine sensor data from a magnetometer, an accelerometer, or a combination (e.g., via an inertial measurement unit—IMU) thereof associated with a vehicle (e.g., associated directly with the vehicle or with a mobile device co-located with the vehicle). The apparatus is also caused to process the sensor data to determine a rotational frequency of at least one tire of the vehicle. The apparatus is further caused to calculate a speed, a tire/wheel diameter, a safety condition, and/or a maintenance condition of the vehicle based on the rotational frequency. The apparatus is further caused to provide the speed, the tire/wheel diameter, the safety condition, and/or the maintenance condition as an output.

According to another embodiment, an apparatus comprises means for determining sensor data from a magnetometer, an accelerometer, or a combination (e.g., via an inertial measurement unit—IMU) thereof associated with a vehicle (e.g., associated directly with the vehicle or with a mobile device co-located with the vehicle). The apparatus also comprises means for processing the sensor data to determine a rotational frequency of at least one tire of the vehicle. The apparatus further comprises means for calculating a speed, a tire/wheel diameter, a safety condition, and/or a maintenance condition of the vehicle based on the rotational frequency. The apparatus further comprises means for providing the speed, the tire/wheel diameter, the safety condition, and/or the maintenance condition as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive. In particular, “speed” and “velocity” are used and can be used interchangeably along this manuscript.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining vehicle information (e.g., speed) using inertial measurement unit (IMU) sensors, according to one embodiment;

FIG. 2 is a diagram of a speed module/speed platform capable of determining vehicle information using IMU sensors, according to one embodiment;

FIG. 3 is a flowchart of a process for determining vehicle information using IMU sensors, according to one embodiment;

FIG. 4 illustrates an example power spectral density of magnetometer data for an example vehicle traveling at a known speed, according to one embodiment;

FIGS. 5A and 5B respectively illustrate an example magnetometer spectrogram and velocity graph for calculating vehicle information, according to one embodiment;

FIG. 6 illustrates an example accelerometer spectrogram for calculating vehicle information, according to one embodiment;

FIG. 7A illustrates an example vehicle speed chart determined from IMU sensor data, according to one embodiment;

FIG. 7B illustrates an example user interface 721 for presenting a warning messaged based on a measured tire diameter, according to one embodiment;

FIG. 7C illustrates an example user interface 741 presenting a warning message based on a detected safety/maintenance issue, according to one embodiment;

FIG. 8 is a diagram of a geographic database, according to one embodiment;

FIG. 9 is a diagram of hardware that can be used to implement an embodiment;

FIG. 10 is a diagram of a chip set that can be used to implement an embodiment; and

FIG. 11 is a diagram of a mobile terminal that can be used to implement an embodiment.

### DESCRIPTION OF SOME EMBODIMENTS

Examples of a method, apparatus, and computer program for determining vehicle information (e.g., speed, tire/wheel diameter, safety/maintenance condition) are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent or similar arrangement. In other instances, well-known structures and devices are shown in block diagram form in order to avoid unnecessarily obscuring the embodiments of the invention.

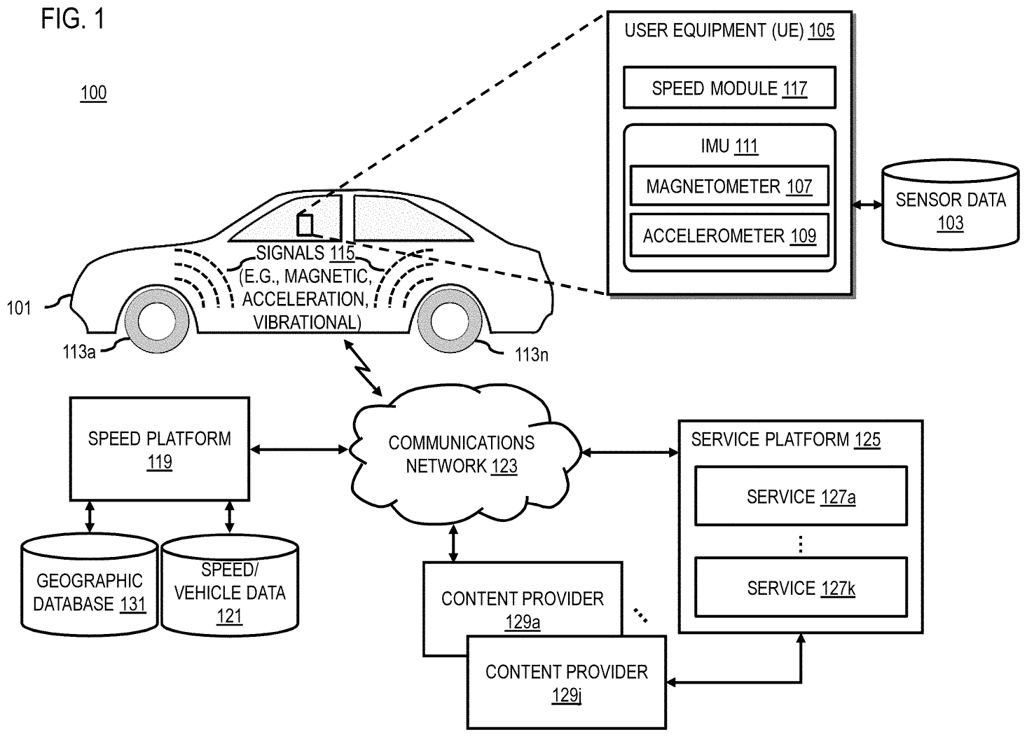

FIG. 1 is a diagram of a system capable of determining vehicle speed using inertial measurement unit (IMU) sensors, e.g., accelerometer and magnetometer, that can be utilized as stand-alone sensors, according to one embodiment. Embodiments of the technology described herein relate to estimating the speed or velocity of a moving body (e.g., a vehicle 101) with the absence of location and/or velocity data such as Global Positioning Satellite (GPS), other Global Navigation Satellite System (GNSS), or dedicated in-vehicle speed sensors. To address the technical challenges related to determining speed data in the absence of GPS, etc., the system 100 of FIG. 1 introduces a capability to use electromagnetic effects and mechanical vibrations as surrogate quantities from which the velocity of the moving body can be inferred. In one embodiment, these surrogate quantities (e.g., sensor data 103 comprising, for instance, measured magnetic and/or acceleration/vibrational signals) are available from smartphones or equivalent mobile devices (e.g., a user equipment (UE) device 105), which contain magnetic sensors (e.g., a magnetometer 107) and/or acceleration sensors (e.g., an accelerometer 109). By way of example, the magnetometer 107 and/or accelerometer 109 may be included in an inertial measurement unit (IMU) 111 along with other sensors such as, but not limited to, gyroscopes, and/or other orientation sensors.

Generally, modern mobile devices or UEs 105 are equipped with multiple sensing units such as GNSS, IMU, pressure sensors, etc. These sensors allow for determination of position, acceleration, magnetic field, angular rotation rate, and in theory, one can use those measurement to know the exact position, velocity, acceleration, and orientation of the device at any time. However, in practice, knowledge of position, velocity, etc. can be limited by the accuracy of the sensors, and the availability of reliable data.

One such situation is when GNSS data become unavailable (e.g., in tunnels, underground parking) or inaccurate (e.g., nearby high-rise buildings) or sparse (e.g., keep low sampling rate to save on power consumption). In theory, one “just” has to use the last known state (e.g., position and velocity) and integrate once over the acceleration to get the updated velocity and integrate for a second time to get the updated location. In practice, one cannot do it because the measurement error of the accelerometer is such that it induces a very rapid drift in velocity and location estimation. The result is that the trajectory can be estimated only for a few seconds before the error accumulation makes it useless. Moreover, acceleration integration produces only the change in velocity, and if the initial velocity is unknown or inaccurate, the resulting position estimation is even poorer. In addition, one component that is often missing is a sensor (e.g., a dedicated speed sensor) that measures directly the linear velocity of the device (e.g., the UE 105).

Accordingly, in one embodiment, the system 100 can use existing sensing components of the IMU 111 or equivalent (e.g., the magnetometer 107, accelerometer 109, or equivalent) to measure directly the speed (e.g., magnitude of the velocity vector) or other characteristics/information (e.g., tire/wheel diameter, vehicle type, safety/maintenance condition, etc.) of a vehicle 101 or other moving body. Historically, the existing components in IMU 111's or other equivalent sensors are not designed to measure the linear velocity of the device (e.g., 105) or other characteristics of a vehicle 101 associated with the device 105 (e.g., tire/wheel diameter, vehicle type, safety/maintenance condition). Such data or information generally have been detected using sensors designed to directly measure those parameters. However, in one embodiment (e.g., in a vehicle setting where the UE 105 is mounted in or otherwise associated with the vehicle 101), the sensor data (e.g., the power spectrum) of the magnetometer 107 and/or accelerometer 109 contain information which is related to the vehicle 101's speed (velocity magnitude) or other vehicle information so that the speed or other vehicle information can be calculated or derived from the sensor data.

For example, in one embodiment, the magnetometer 107 is sensitive to changes in the magnetic field. In most cases, the tires 113a-113n (also collectively referred to as tires 113) of the vehicle 101 are steel-belted radial tires that tend to be magnetized. The net effect is that tires 113 behave as rotating magnets. The rotational frequency can be measured with the magnetometer 107 as magnetic signals 115. The system 100 (e.g., via a speed module 117 local to the UE and/or via a speed platform 119 on the network side) can then process sensor data to calculate the speed from the rotational frequency to generate speed/vehicle data 121 for the vehicle 101. The speed/vehicle data 121 represents, for instance, one or more speed measurements determined according to the embodiments described herein.

In another example embodiment, the accelerometer 109 can also be used alone or in combination with the magnetometer to determine rotational frequency of the tires 113 of the vehicle 101. For example, vehicle tires 113 generally have some level of imbalance. At high speeds, even a tiny imbalance in weight can become a large imbalance in centrifugal force, causing the wheel/tire assembly to spin with a kind of “galumphing” motion. This usually translates into a vibration in the vehicle 101 as well as irregular and damaging wear on the tires 113. This galumphing motion has the same frequency as the tire rotation and is captured by the accelerometer 109 as vibrational signals 115. As described above, the rotational frequency determined from the vibrational signals 115 can then be used to generate speed/vehicle data 121 for the vehicle 101.

It is noted that the magnetometer 107 and/or accelerometer 109 discussed with respect to the embodiments described herein are provided by way of illustration and not as limitations. It is contemplated that any other type of sensor (e.g., other than dedicated speed sensors or GNSS/GPS) that can provide surrogate information for deriving speed can be used. For example, microphones or other acoustic sensors can be used to record tire sounds resulting from “galumphing” motion of imbalanced tires 113 can be processed to determine rotational frequency and ultimately speed.

In summary, location and velocity information traditionally can be obtained in a few ways:
a. Use GNSS data (e.g., GPS) to get location and take the time derivative for the velocity. This is a valid method, but it depends on having good location data. Many times, the data might be unavailable (e.g., when the receiver is traveling underground), sparsely available (e.g., due to local interferences or weak satellite signals), or very inaccurate (e.g., near high-rise buildings). Direct measurement of the velocity using alternative sensors according to the embodiments described herein would advantageously make it easier to detect invalid location measurements.
b. Use the IMU to get the acceleration in world coordinates, and time-integrate to obtain the change in velocity and position. This approach is very limited in accuracy due to the measurement error of the IMU components in mobile devices (e.g., UEs 105), mainly the accelerometer 109. The error accumulation makes position change estimation valid for only a few seconds before the error exceeds acceptable thresholds. Moreover, this method produces only the change in velocity and position, and not their absolute value. In one embodiment, direct measurement of the velocity according to the embodiments described herein can be used in a sensor fusion mode for better estimation of location.
c. Use sensor fusion of GNSS and accelerometer data in schemes such as Kalman filtering. Such methods employ a physical model of motion and use it in conjunction with sensor data to produce velocity and acceleration. These methods are the current state of the art, but they are as good as the data they get and the complexity level of the physical model. In one embodiment, direct measurement of the velocity according to the embodiments described herein can add an important sensor that is absent from traditional approaches and can be used for improved accuracy.

Under certain scenarios, there are additional technical challenges associated with using the magnetometer 107 and/or accelerometer 109 for speed measurements according to the embodiments described herein. These include but are not limited to:
a. Magnetic field is position dependent, and generally weak. Thus, magnetic background should be estimated at every measurement positing. The tires effect depends to some extent on the combination of tires model, age and history, car type, and competes with the presence of other interfering electromagnetic devices nearby. Electric/hybrid cars are more challenging than regular cars.
b. The accelerometer-based tires imbalance effect is most prominent at high speeds and depends on the extent of imbalance.

To address these additional challenges, in some embodiment, the system 100 can apply additional signal processing for signal cleanup, remove background signals, apply filtering, and/or the like. These additional embodiments are described in more detail further below.

In one embodiment, the various embodiments described herein opens the way for much more accurate navigation and/or other location-based services by providing speed or other vehicle data 121 (e.g., information derived from sensors not normally used for the purpose of speed detection but generally available in most modern phones and mobile devices), especially when GNSS data is unavailable or sparse. For example, the speed/vehicle data 121 can be provided by the system 100 as an output over a communications network 123 to a service platform 125 including one or more services 127a-127k (also referred to as services 127). As discussed above, the services 127 can include, but are not limited to, mapping services, navigation services, and/or the like that can combine the speed/vehicle data 121 with digital map data (e.g., a geographic database 131) to provide location-based services. It is also contemplated that the services 127 can include any service that uses the speed/vehicle data 121 to provide or perform any function. In one embodiment, the speed/vehicle data output 121 can also be used by one or more content providers 129a-129j (also collectively referred to as content providers 129). These content providers 129 can aggregate and/or process the speed/vehicle data 121 to provide the processed data to its users such as the service platform 125 and/or services 127.

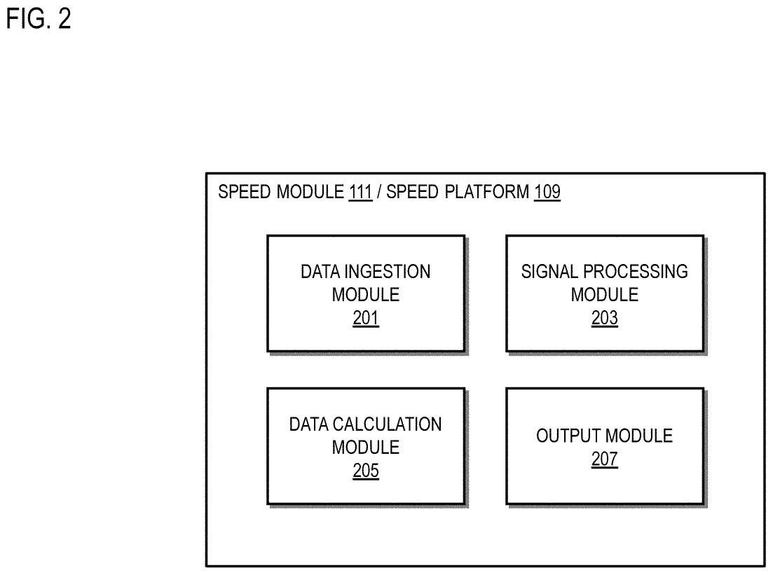

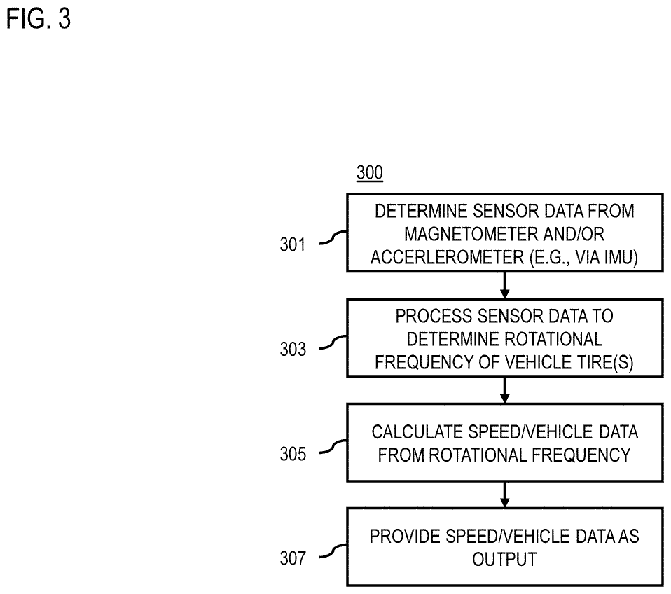

FIG. 2 is a diagram of a speed module/speed platform capable of determining vehicle information (e.g., speed) using IMU or equivalent sensors, according to one embodiment. In one embodiment, the speed module 117 (e.g., a local component) and/or speed platform 119 (e.g., a network/cloud component) may perform one or more functions or processes associated with determining vehicle information based on IMU or equivalent sensors. By way of example, as shown in FIG. 2, the speed module 117 and/or speed platform 119 include one or more components for performing functions or processes of the various embodiments described herein. It is contemplated that the functions of these components may be combined or performed by other components of equivalent functionality. In one embodiment, the speed module 117 and/or speed platform 119 include a data ingestion module 201, signal processing module 203, data calculation module 205, and output module 207. The above presented modules and components of the speed module 117 and/or speed platform 119 can be implemented in hardware, firmware, software, or a combination thereof. In one embodiment, the speed module 117, speed platform 119, and/or any of their modules 201-207 may be implemented as a cloud-based service, local service, native application, or combination thereof. The functions of speed module 117, speed platform 119, and modules 201-207 are discussed with respect to FIGS. 3-8 below.

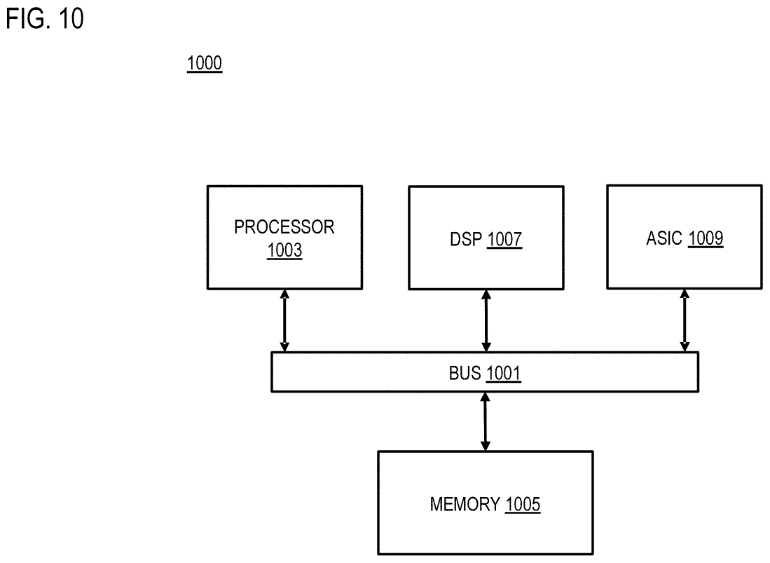

FIG. 3 is a flowchart of a process for determining vehicle information using IMU sensors, according to one embodiment. In various embodiments, the speed module 117, speed platform 119, and/or any of their modules 201-207 may perform one or more portions of the process 300 and may be implemented in, for instance, a chip set including a processor and a memory as shown in FIG. 10. As such, the speed module 117, speed platform 119, and/or any of their modules 201-207 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all the illustrated steps.

As discussed above, existing components (e.g., magnetometers 107, accelerometers 109, etc.) in traditional IMU 111's are not designed to measure the linear velocity of the device (e.g., a UE 105 in which the IMU 111 is installed) or other characteristics of a vehicle 101 associated with the device (e.g., tire/wheel diameter, vehicle type, safety/maintenance condition, etc.). In one embodiment, the process 300 provides a practical approach for measuring vehicle velocity and/or other vehicle information (e.g., tire/wheel diameter, vehicle type, safety/maintenance condition, etc.) using the magnetometer 107 and/or accelerometer 109 components of the IMU 111, taking advantage of mechanical and material properties of the tires 113 of the vehicle 101.

For example, in step 301, the data ingestion module 201 determines sensor data 103 from a magnetometer 107, an accelerometer 109, or a combination thereof (or from equivalent sensors) associated with a vehicle 101. The sensor data 103, for instance, include measurements of signals 115 representing changes in the magnetic field (e.g., magnetic measurements), acceleration, and/or mechanical/vibrational oscillations of the vehicle 101 caused by the rotation of the tires 113 of the vehicle 101. In one embodiment, the magnetometer 107, accelerometer 109, and/or equivalent sensors can be installed within a mobile device or smartphone (e.g., a UE 105) mounted or otherwise traveling within the vehicle 101. For example, the UE 105 can be mounted to the dashboard or other fixed position within the vehicle 101 or carried by a driver/passenger of the vehicle 101. The sensors can be standalone sensors within the UE 105 or part of an IMU 111 within the UE 105. It is noted, however, that embodiments in which the sensors are included within the UE 105 are provided by way of illustration and not as a limitation. In other embodiments, it is contemplated that the sensors (e.g., the magnetometer 107 and/or accelerometer 109) may be mounted externally to the UE 105 (e.g., as a component of the vehicle 101 or other device within the vehicle 101). In addition, the speed module 117 for calculating the speed or other characteristic/information of the vehicle 101 according to the embodiments described herein need not reside within the UE 105 and can also be included as a component of the vehicle 101 and/or any other device internal or external to the vehicle 101.

As discussed above, in one embodiment, the sensor data 103 includes magnetic measurements or magnetic signals from the tires 113 of the vehicle 101. Generally, the most prevalent car tire technology has been steel-belted radial tires (SBRT). The steel, for instance, is used to improve the strength and reduce wearing of the tires 113. In addition, SBRT usually have some degree of non-uniform magnetization that is the result of the manufacturing process. The net result is that the tires 113 can act as weak magnets, and tire rotation induces a time dependent magnetic field whose frequency (e.g., rotational frequency) is directly proportional to the speed of the vehicle 101. This relationship is illustrated in the following speed/frequency relationship equation:

s=|\vec{v}|=πdfₜᵢᵣₑ

where, s is the speed, v is the vehicle velocity, d is the tire diameter, and fₜᵢᵣₑ is the rotational frequency of the tire.

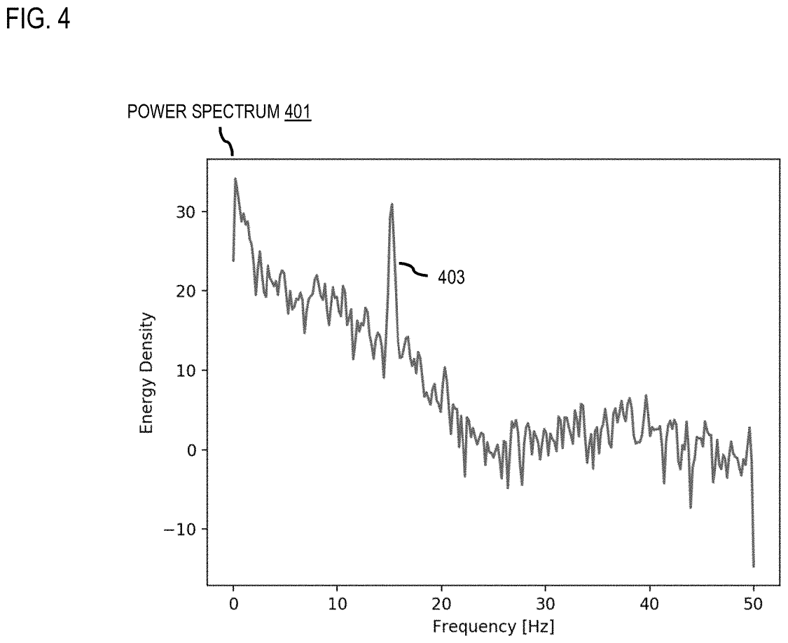

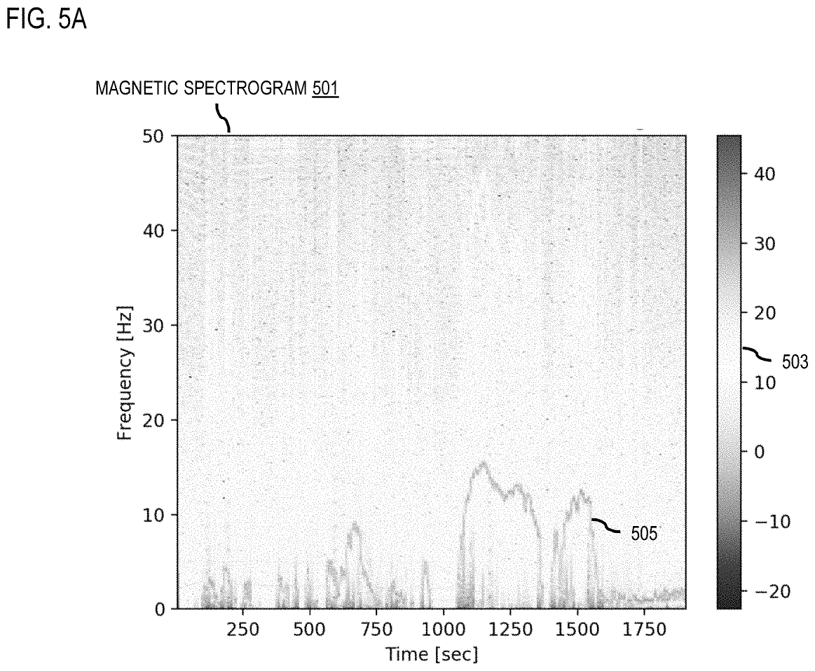

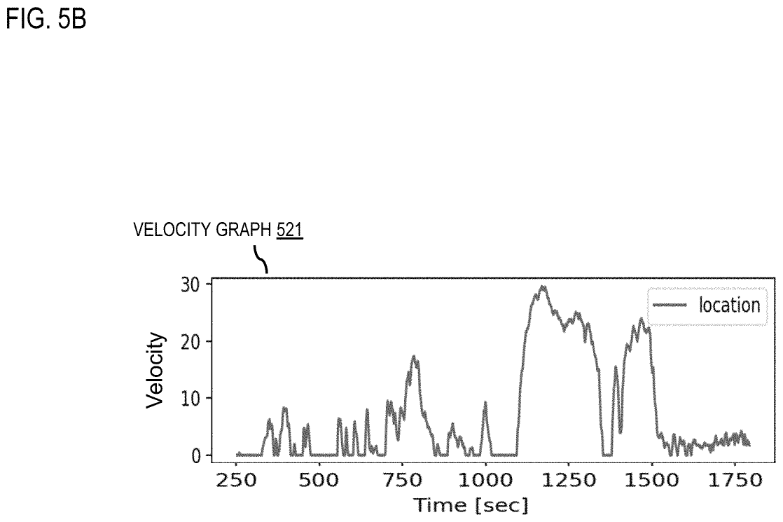

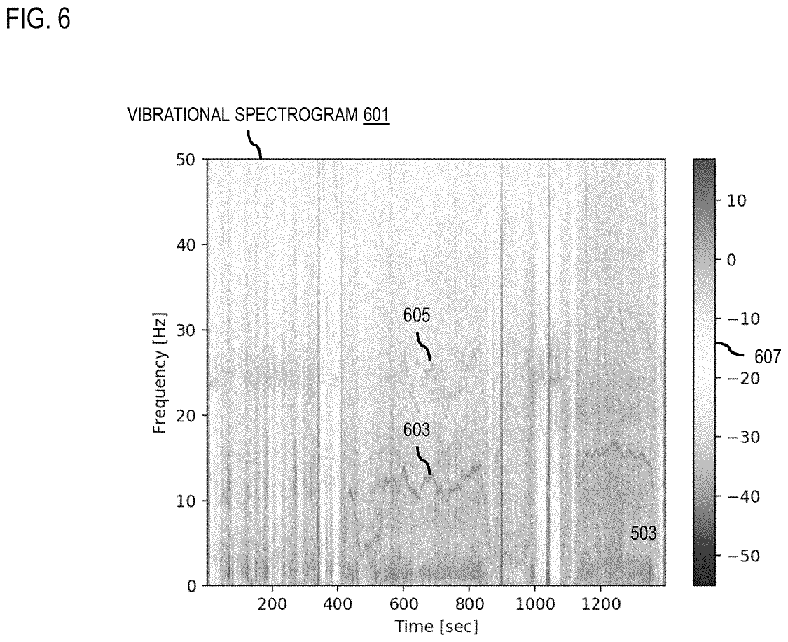

Accordingly, in step 303, the signal processing module 203 can process the sensor data 103 (e.g., determined according to step 301 or equivalent) to determine a rotational frequency of at least one tire 113 of the vehicle 101. In one embodiment, signal processing module 203 can determine the rotational frequency from the magnetic and/or acceleration/vibrational signals 115. FIGS. 4 and 5A-5B below discuss an example embodiment in which the rotational frequency is determined from magnetic signals 115 and FIG. 6 below discuss an example embodiment in which the rotational frequency is determined from acceleration/vibrational signals 115. The magnetic and vibrational embodiments can be used alone or in combination.

According to an embodiment of using magnetic signals 115, the signal processing module 203 determines a magnetic signal 115 from the sensor data 103 from the magnetometer 107. Then, the rotational frequency (e.g., of the tire 113) is determined based on the magnetic signal 115. The magnetic signal 115, for instance, represents one or more changes in a magnetic field (e.g., as described below with respect to FIGS. 4 and 5A-5B).

FIG. 4 is an example power spectral density of magnetometer data for an example vehicle traveling at a known speed, according to one embodiment. More specifically, FIG. 4 illustrates an example of the magnetic power spectrum 401 (e.g., a plot of the measured energy density of the magnetic signal 115 across different frequencies of the signal 115) taken during a test drive of an example vehicle 101. A UE 105 device equipped with a magnetometer 107 was mounted within the vehicle 101 (e.g., located in a holder in the center of the dashboard) to measure the magnetic signal 115 used to generate the magnetic power spectrum 401. In this example, the vehicle 101 was traveling at a constant speed (e.g., ˜105 km/h), and the resulting peak 403 at ˜15 Hz is in perfect agreement with the expected value based on the speed/frequency relationship equation above given the known tire diameter of the vehicle 101. The peak 403 represents the measured rotational frequency of the tires 113 of the vehicle 101 when the vehicle 101 is traveling at speed (e.g., ˜105 km/h).

In one embodiment, the signal processing module 203 can process the magnetic signal 115 of the sensor data 103 to determine the power spectral density of magnetic field changes of the tires 113 over time. This power spectral density over time can be represented using a spectrogram as shown in FIG. 5A which illustrates an example magnetometer spectrogram 501 for calculating vehicle speed, according to one embodiment. The spectrogram 501, for instance, represents the magnetic signal 115 as a plot of the magnetic energy time series relative to a corresponding frequency of the magnetic signal 115. The energy density for each frequency at each time can be represented using a different shade according to the legend 503. In this way, the frequency corresponding to the peak energy density at each time can be more easily detected. For example, the frequencies corresponding to the peak energy densities over time can be detected as ridge lines 505 (e.g., represented by shading corresponding to higher energy densities). In one embodiment, the ridge lines 505 correspond to the rotational frequencies of the tires 113 of the vehicle 101 over time, e.g., from which vehicle speed can be determined.

For comparison, direct speed data measured for the vehicle 101 (e.g., using GNSS) over the same time period is presented in the velocity graph 521 of FIG. 5B. As shown, there is general agreement between the ridge lines 505 of the spectrogram 501 of FIG. 5A (e.g., created by the shift in tire rotational frequency over time) and the corresponding speeds indicated in the velocity graph 521.

While multiple tires 113 of the vehicle 101 generally will have the same rotational frequency, there can be situations where the tires 113 are rotating at different frequencies (e.g., failure or malfunctioning of an axle, differential, or other component of the vehicle 101). Under this possible scenario, multiple ridgelines over the same time period may be apparent (not the case in the examples of FIGS. 5A and 5B). Accordingly, in some embodiments, the appearance of multiple ridge lines 505 over the same time period can be used by the system 100 indicate possible malfunctioning or the need to perform maintenance on the vehicle 101. The possible malfunction or the need to perform maintenance represents, for instance, a safety and/or maintenance condition of the vehicle 101.

The embodiments described herein take advantage of surrogate magnetic signal data to measure vehicle velocity, but under some scenarios, these magnetic signals 115 can be obscured or suffer from interference. Therefore, there are additional technical challenges associated with getting a clean measurement of the power spectrum and identifying the right peak among many that are present.

In one embodiment, the signal processing module 203 can apply one or more optional signal processing or preprocessing procedures. In the description below, it is assumed that the mobile device (e.g., UE 105) collecting the sensor data 103 is fixed and stationary within the vehicle 101 to reduce potential interference or noise in the signal data. However, it is also contemplated that the embodiments described herein are also applicable when the UE 105 is not in a fixed location (e.g., held by a driver or passenger, placed on a surface in the vehicle without mounting, etc.). In the case of the non-fixed mounting of the UE 105, the signal processing module 203 can apply more preprocessing steps to reduce noise or error in the signals. Examples of the various signal processing or preprocessing steps of the magnetic signal 115 can include but are not limited to the various embodiments described below.

In one embodiment, the magnetic signal processing can include signal cleanup (e.g., median filter, low-pass, etc.). For example, the signal processing module 203 can apply different filters or equivalent processes/algorithms to remove noise, detect outliers, etc. from the magnetic signal 115 of the sensor data 103 to improve data quality.

In one embodiment, the magnetic signal processing module 203 can perform additional processing options such as but not limited to:
1. Bare magnetic field components—In one embodiment, the magnetic signal 115 is a measure of a magnetic field that is represented as a vector. The signal processing module 203 can process the magnetic field vector into its individual filed components with respect to different spatial axes (e.g., x-axis, y-axis, and z-axis of a three-dimensional magnetic field vector). In one embodiment, the individual basic components of the field can be processed individually or in combination to determine respective rotational frequencies in case the error or noise is limited to only one or some of the field components.
2. Total magnetic energy—In one embodiment, the signal processing module 203 can process the magnetic signal 115 to determine total magnetic energy data, and then the rotational frequency can be determined further based on the total magnetic energy data. By way of example, the total magnetic energy density measured across all frequencies of the magnetic power spectral density data. Then energy peaks at corresponding frequencies can be determined relative to the total magnetic energy at a given measurement time.
3. Optimal rotation—In one embodiment, since the magnetic field is a vectoral field, the field arriving at the sensors (e.g., magnetometer 107 and/or accelerometer 109) from the tires 113 can have a specific direction. In one embodiment, rotation to this axis system (e.g., based on the specific direction of the arriving field) can ensure that most of the information associated with tire rotation is contained in one axis. In other words, the signal processing module 203 can process the magnetic signal 115 to determine a direction of the magnetic signal 115 associated with the at least one tire 113 of the vehicle 101. The rotational frequency is then determined further based on a portion of the magnetic signal 115 associated with the direction.

In some scenarios, the magnetic signal 115 picked up in the sensor data 103 can be susceptible to interference from other magnetic and/or electrical fields in the vehicle 101 itself. The magnetic background in the vehicle 101 can then be assessed. Accordingly, in one embodiment, the signal processing module 203 can optionally measure of the magnetic background in or near the vehicle 101. The signal processing module 203 can then subtract or otherwise account for the magnetic background when processing the sensor data 103.

In one embodiment, the signal processing module 203 can also identify peaks in the power spectrum of the measured magnetic energy density. As described above, the peaks represent the likely rotational frequency of the tires 113 of the vehicle 101 based on the detected magnetic energy densities. The identification of the peaks can be based on distinguishing the peak from background noise in the magnetic signal 115. For example, the signal processing module 203 can apply criteria such as identifying only those peaks that are statistically different from the background noise (e.g., peak height greater than n standard deviations from the background noise level).

In yet another embodiment, the signal processing module 203 can apply various filtering criteria for selecting the peak or peaks that correspond to the rotational frequency of the tires 113 of the vehicle 101. By way of example, the processing of the sensor data 103 can include or otherwise be based on at least one of the following criteria or processes:
1. Velocity limits—In one embodiment, the signal processing module 203 can apply at least one velocity limit when selecting a peak to represent the rotational frequency of a tire 113. The velocity limit can be used to derive a maximum rotational frequency that the vehicle 101 would be expected to have (e.g., based on the maximum or expected performance of the vehicle 101). For example, if a vehicle 101 is not capable of driving more than 150 km/h, peaks associated with rotational frequencies corresponding to speeds higher than this velocity limit can be excluded. In other embodiments, the velocity limit can be based on the speed limit, observed media speed, etc. on a certain road or segment (e.g., set at some designated factor above speed limit such as, but not limited to, 1.5× speed limit). In this way, peaks associated with speeds that are not possible or probable on a road segment can be excluded during the processing.
2. Identification of fundamental frequency and harmonics—In one embodiment, the magnetic signal 115 in the sensor data 103 can include the fundamental frequency (e.g., associated with the actual rotational frequency of the tire 113) as well as related harmonics or harmonic frequencies. Accordingly, the signal processing module 203 can identify and filter out the harmonic frequencies.
3. Use of acceleration information from the accelerometer 109—In one embodiment, the signal processing module 203 can use the acceleration information from a co-located accelerometers to estimate the expected frequency shift between two measurement windows
4. Ridge line detection in spectrogram—In one embodiment, the magnetic signal data 115 of the sensor data 103 can be transformed into a spectrogram representation as described in the embodiments above. Frequency peaks corresponding to peaks in magnetic energy density across time can then be detected as ridge lines that represent the rotational frequencies of the tires 113 of a vehicle 101 over time. For example, the signal processing module 203 can process the spectrogram using ridge line detection processes such as, but not limited to, a Hough transform, Sobel edge detection, Laplacian line detection, parametric feature detection, pixel value thresholding, maximum likelihood estimator, convolution of line detection masks, or equivalent.

In one embodiment, the sensor data 103 and signal 115 can represent a mechanical measurement (e.g., measurement of the accelerations/vibrations of the vehicle 101) indicative of rotational frequency of the tires. Accordingly, in one embodiment of the step 303 of the process 300, the signal processing module 203 determine a vibrational signal 115 from the sensor data 103 of the accelerometer 109. The rotational frequency can then be determined based on the vibrational signal 115 alone or in combination with the magnetic signal 115 described in the embodiments above.

As previously described, vehicle tires 113 generally have some level of unbalancing. At high speeds, a tiny imbalance in weight can easily become a large imbalance in centrifugal force, causing the wheel/tire assembly to spin with a kind of “galumphing” motion. This usually translates into a vibration in the vehicle 101 as well as some very irregular and damaging wear on the tires 113. This galumphing motion has the same rotational frequency as the tire rotation and is captured by the accelerometer 109, mainly at high velocities. In one embodiment, to determine the rotational frequency of the tires 113, the signal processing module 203 can generate a power spectrum of the vibrational signal 115 (e.g., according to an analogous process as described in the embodiments that process the magnetic signal 115), and identify one or more peaks of the power spectrum. The rotational frequency can then be determined based on the one or more peaks.

In one embodiment, the power spectrum is represented as an accelerometer spectrogram. FIG. 6 is an example accelerometer spectrogram 601 for calculating vehicle speed, according to one embodiment. As shown, the ridge line 603 corresponds to the peak energy densities of the measured vibrational signal 115 at each time. Under some cases, harmonic frequencies associated with the peak rotational frequency can also be detected (e.g., as a fainter ridge line 605). This harmonic ridge line 605 can be filtered or otherwise ignored to compute the rotational frequency. As with the example of FIG. 5A, the shading of the spectrogram represents the measured energy densities according to the legend 607. The signal processing module 203 can detect the fundamental ridge line 603 as an indicator of the rotational frequency of the tires 113 of the vehicle 101.

As with the magnetic signal 115, the vibrational signals 115 can also be obscured or suffer from interference. Therefore, there are additional technical challenges associated with getting a clean measurement of the vibrational power spectrum and identifying the right peak among many that are present.

In one embodiment, the signal processing module 203 can apply one or more optional signal processing or preprocessing procedures to the vibrational signal 115. Examples of the various signal processing or preprocessing steps of the magnetic signal 115 can include but are not limited to the various embodiments described below.

In one embodiment, the magnetic signal processing can include signal cleanup (e.g., median filter, low-pass, etc.). For example, the signal processing module 203 can apply different filters or equivalent processes/algorithms to remove noise, detect outliers, etc. from the magnetic signal 115 of the sensor data 103 to improve data quality. In another embodiment, the signal processing module 203 can also calculate an energy time series of the vibrational spectrogram over time. For example, the vibrational signal data 115 can be broken into a series of chunks of a time domain and then the resulting rotational frequencies (e.g., based on energy densities) can be compared over the chunks to determine signal changes over time.

In some scenarios, the acceleration/vibrational signal 115 picked up in the sensor data 103 can be susceptible to interference from other accelerations/vibrations in the vehicle 101 not caused by tire imbalance. The vibrational background in the vehicle 101 can then be assessed. Accordingly, in one embodiment, the signal processing module 203 can optionally measure of the vibrational background in or near the vehicle 101. The signal processing module 203 can then subtract or otherwise account for the vibrational background when processing the sensor data 103.

In one embodiment, the signal processing module 203 can also identify peaks in the power spectrum of the measured magnetic energy density. As described above, the peaks represent the likely rotational frequency of the tires 113 of the vehicle 101 based on the detected magnetic energy densities. The identification of the peaks can be based on distinguishing the peak from background noise in the magnetic signal 115. For example, the signal processing module 203 can apply criteria such as identifying only those peaks that are statistically different from the background noise (e.g., peak height greater than n standard deviations from the background noise level).

In yet another embodiment, the signal processing module 203 can apply various filtering criteria for selecting the peak or peaks of the vibrational signal 115 that correspond to the rotational frequency of the tires 113 of the vehicle 101. By way of example, the processing of the sensor data 103 can include or otherwise be based on at least one of the following criteria or processes:
1. Velocity limits—In one embodiment, the signal processing module 203 can apply at least one velocity limit when selecting a peak to represent the rotational frequency of a tire 113. The velocity limit can be used to derive a maximum rotational frequency that the vehicle 101 would be expected to have (e.g., based on the maximum or expected performance of the vehicle 101). For example, if a vehicle 101 is not capable of driving more than 150 km/h, peaks associated with rotational frequencies corresponding to speeds higher than this velocity limit can be excluded. In other embodiments, the velocity limit can be based on the speed limit, observed media speed, etc. on a certain road or segment (e.g., set at some designated factor above speed limit such as, but not limited to, 1.5× speed limit). In this way, peaks associated with speeds that are not possible or probable on a road segment can be excluded during the processing.
2. Identification of fundamental frequency and harmonics—In one embodiment, the vibrational signal 115 in the sensor data 103 can include the fundamental frequency (e.g., associated with the actual rotational frequency of the tire 113) as well as related harmonics or harmonic frequencies. Accordingly, the signal processing module 203 can identify and filter out the harmonic frequencies.
3. Use of acceleration information from time domain data—In one embodiment, the signal processing module 203 can estimate the expected frequency shift between two measurement time windows. The search space for the rotational frequency can then be constrained based on the expected frequency shift between two measurement windows.
4. Ridge line detection in spectrogram—In one embodiment, the vibrational signal data 115 of the sensor data 103 can be transformed into a spectrogram representation as described in the embodiments above. Frequency peaks corresponding to peaks in vibrational energy density across time can then be detected as ridge lines that represent the rotational frequencies of the tires 113 of a vehicle 101 over time. For example, the signal processing module 203 can process the spectrogram using ridge line detection processes such as, but not limited to, a Hough transform, Sobel edge detection, Laplacian line detection, parametric feature detection, pixel value thresholding, maximum likelihood estimator, convolution of line detection masks, or equivalent.

In step 305, after determining the rotational frequency of the tires 113 of a vehicle 101 according to the embodiments described with respect to step 303, the data calculation module 205 can calculate a speed of the vehicle based on the rotational frequency. In one embodiment, the speed can be calculated according to the speed/frequency relationship equation described above and presented again below:

s=|\vec{v}|=πdfₜᵢᵣₑ

where, s is the speed, v is the vehicle velocity, d is the tire diameter, and fₜᵢᵣₑ is the rotational frequency of the tire. In this case, fₜᵢᵣₑ is determined according to the embodiments described above. The data calculation module 205 can then determine the diameter of the at least one tire 113 of the vehicle 101 for which the speed is being calculated, so that the speed can be calculated further based on the diameter. The data calculation module 205, for instance, can determine the diameter based on specification data associated with the make and model of the vehicle 101, based on user input, based on reading the diameter from the tires 113, and/or any other equivalent means. In one embodiment, when the actual diameter of the tires 113 is not known or otherwise available, the data calculation module 205 can use a default tire diameter value to approximate the true diameter.

In one embodiment, if the speed s is known (e.g., a speed determined from available GNSS measurements or other available speed sensors) and the tire diameter d is not known, the data calculation module 205 can instead calculate the diameter d of at least one tire 113 of the vehicle 103 based on the rotational frequency. The calculation, for instance, can be based on the following equation:

$$d = \frac{s}{π {f}_{tire}}$$

wherein, d is the tire diameter, s is the speed and fₜᵢᵣₑ is the rotational frequency of the tire.

In one embodiment, the data calculation module 205 can used the determined the calculated tire diameter d to classify or infer the type of vehicle 101 from which the sensor data was collected. The data calculation module 205, for instance, can classify the vehicle type based on a range of tire diameter values associated with each vehicle type. Table 1 below illustrates example ranges for classifying different types of vehicles based on tire diameter d sizes. As shown, if a calculated tire diameter d for a vehicle of interest falls within the range specified for a given vehicle type, the vehicle of interest can be classified as the corresponding vehicle type.

TABLE 1

| Tire Diameter Range | Vehicle Type |
|---|---|
| ≥13 inches and <16 inches | Compact Vehicle |
| ≥16 inches and <19 inches | Full-size Vehicle |
| ≥19 inches and <22 inches | Sports Utility Vehicle |
| ≥22 inches | Public Transport Vehicle |

It is noted that the above example of classifying a vehicle type based on a calculated tire diameter d is provided by way of illustration and is not intended as a limitation. It is contemplated that the data calculation module 205 can use any means to determine a vehicle type based on the tire diameter d as an input (e.g., machine learning algorithms or other predictive models).

In another embodiment, the data calculation module 205 can calculate a safety condition, maintenance condition, or a combination thereof of the vehicle 101 based on the rotational frequency and/or the speed/vehicle information derived therefrom. By way of example, a safety condition refers to any condition of the vehicle 101 that can cause to operation of the vehicle to fall outside of manufacturer specified safety parameters, and a maintenance condition refers to any condition of the vehicle 101 that can indicate a need for repair or service. In one embodiment, the data calculation module 205 can determine whether the tires 113 of the vehicle 101 are rotating at different frequencies. As described above, tires 113 that are rotating at different frequencies can be identified based on the appearance of multiple ridgelines in a power spectrum of the magnetic/acceleration/vibrational signals 113 of the sensor data 103. Accordingly, the data calculation module 205 can apply threshold ranges for determining when detected rotational differences between the tires 113 a maintenance condition and/or a safety condition. For example, the threshold rotational difference for a safety condition can be set higher than a maintenance condition, so that repairs or service can be performed before the condition escalates from a maintenance condition (e.g., a vehicle 101 can still be operated but service should be performed) to a safety condition (e.g., a vehicle 101 should not be operated until service/repairs are performed).

In one embodiment, the data calculation module 205 can process sensor data, determined rotational frequencies, and/or other derived values (e.g., speed, tire diameter, etc.) to identify a more specific issue creating the determined safety/maintenance condition. For example, the detected safety/maintenance conditions can include but are not limited to a wheel balancing, a low air pressure, and/or other general anomaly of the vehicle 101. To detect a wheel balancing issue that rises to a safety/maintenance condition, the data calculation module 205 can determine whether the detected vibrational signal 115 is above a threshold value or has increased beyond the threshold value over time. As another example, a detected change (e.g., a decrease) in the diameter of a tire 113 over time by more than a threshold value can indicate a low air pressure condition of a tire 113. As a more general embodiment, the data calculation module 205 can monitor the rotational frequencies, signals 115, and/or any corresponding derived values (e.g., speed, tire diameter, vehicle type, etc.) over a time and/or frequency domain. If the monitored values change by more than a threshold value over the monitoring period, the data calculation module can identify that there is a safety/maintenance condition.

In step 307, the output module 207 can provide the speed or other vehicle information (e.g., tire diameter, vehicle type, safety/maintenance condition, etc.) of the vehicle 101 as an output. The output, for instance, can be provided or transmitted to any service, application, function, component, system, device, or equivalent that requests the speed/vehicle data 121. For example, the speed/vehicle data output can be provided to the service platform 125, any of the services 127, any of the content providers 129, and/or the like.

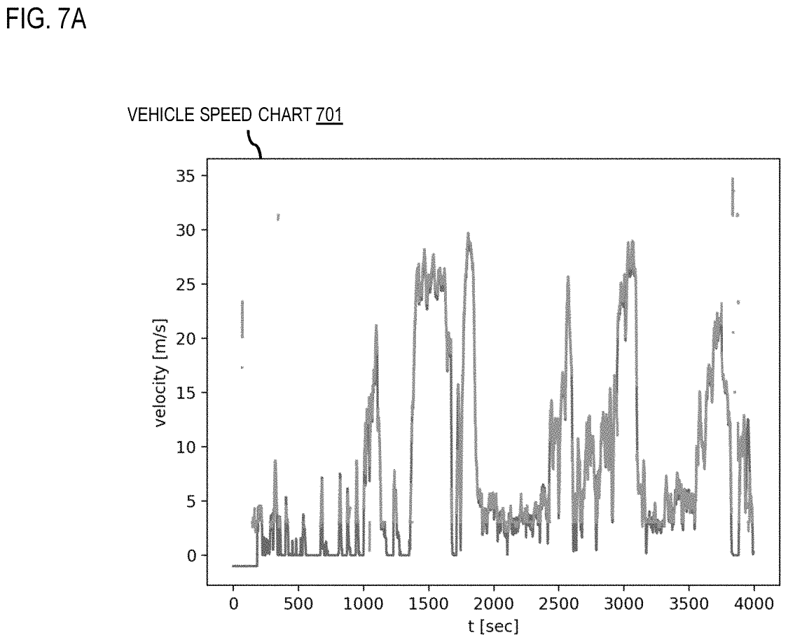

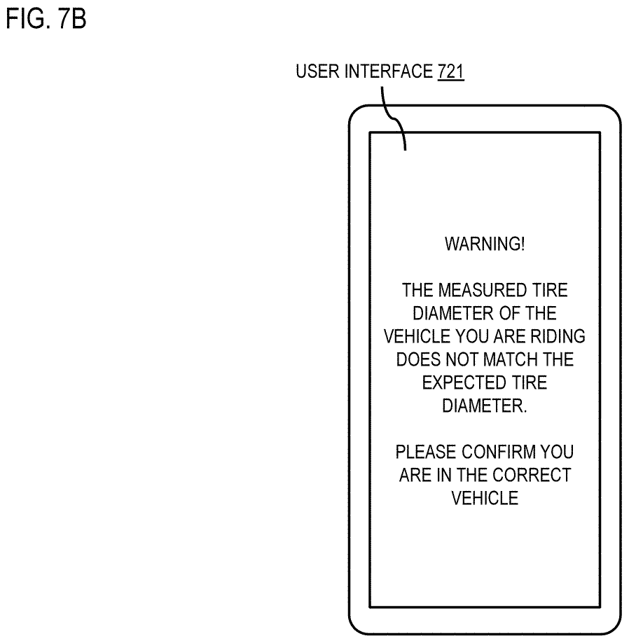

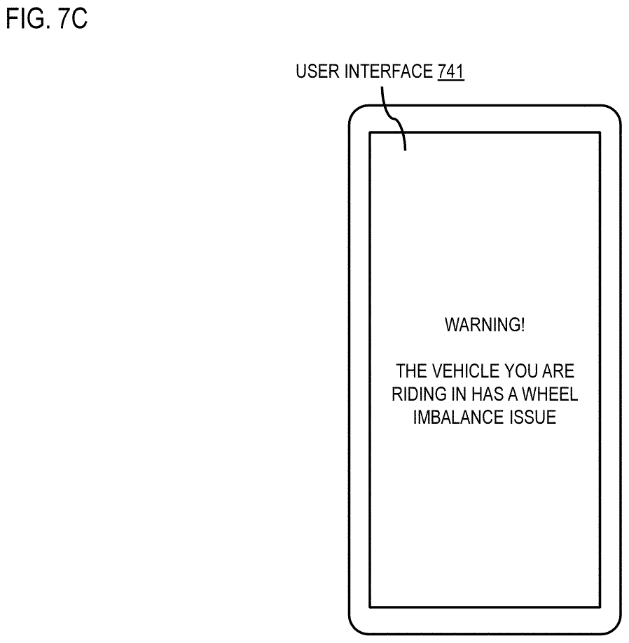

FIG. 7A is an example output comprising a vehicle speed chart 701 determined from IMU sensor data 103, according to one embodiment. The chart 701 is an example of one type of output that can be provided by the system 100. The chart 701 was generated by acquiring sensor data 103 from a magnetometer 107, accelerometer 109, or other equivalent IMU sensor (e.g., contained within a UE 105 mounted in or otherwise associated with a vehicle 101). The sensor data 103 includes magnetic and/or vibrational signals 115 from which the rotational frequency of the tires 113 of the vehicle 101 can be determined. The system 100 then calculates the speed of the vehicle 101 of the time period in which the sensor data 103 was collected. This vehicle speed chart 701 presents the calculated speed values as a plot of the vehicle 101's velocity versus time.

In one embodiment, the speed platform 119 can output the tire diameter and/or vehicle type determined from the rotational frequency of the IMU sensor data 103 for applications or services 127 in which determining vehicle class or type is used. For instance, a safety application or service 127 can use the vehicle type data to make sure that a passenger took the right ride-sharing vehicle or taxi. In this case, the service 127 can assume that the vehicle type of the correct vehicle has a known or expected tire diameter or vehicle type. The service 127 can then match the expected tire diameter or vehicle type with the measure value to confirm whether the passenger is in the correct vehicle. FIG. 7B illustrates an example user interface 721 for presenting a warning messaged based on a measured tire diameter, according to one embodiment. In the example of FIG. 7B, the speed platform 119 has measured the tire diameter of the vehicle 101 in which a passenger is riding based on the embodiments described herein. The measured diameter is provided to a service 127 that compares the measured value to determine whether the passenger is in the expected vehicle. As shown in FIG. 7B, the comparison shows there is a difference between measured and expected values beyond the applicable threshold, and the service 127 presents the user interface 721 to present a warning message “Warning! The measure tire diameter of the vehicle you are riding does not match the expected tire diameter. Please confirm that you are in the correct vehicle.”

In another embodiment, the safety application or service 127 can also provide warnings to passengers of potential maintenance issues in the vehicles in which they are riding. When a passenger boards a vehicle (e.g., ride-sharing vehicle or taxi), the service 127 can begin detecting potential safety/maintenance issues (e.g., wheel imbalance, low air pressure, other anomalies) with the vehicle according to the embodiments described herein. If a safety/maintenance condition is detected, then a warning message can be presented. FIG. 7C illustrates an example user interface 741 presenting a warning message based on a detected safety/maintenance issue, according to one embodiment. In the example of FIG. 7C, the speed platform 119 has detected a wheel imbalance greater than a threshold level based on the detected differences in the rotational frequencies of the tires of the vehicle the passenger is riding in. In response, the service 127 present the user interface 741 to warn the passenger that “The vehicle you are riding in has a wheel imbalance issue.”

Returning to FIG. 1, the system 100 comprises one or more vehicles 101 associated with one or more UEs 105 having respective speed modules 117 and/or connectivity to the speed platform 119. By way of example, the UEs 105 may be a personal navigation device (“PND”), a cellular telephone, a mobile phone, a personal digital assistant (“PDA”), a watch, a camera, a computer, an in-vehicle or embedded navigation system, and/or other device that is configured with multiple sensors types (e.g., magnetometers 107, accelerometers 109, etc.) that can be used for determined vehicle speed according to the embodiments described herein. It is contemplated, that the UE 105 (e.g., cellular telephone or other wireless communication device) may be interfaced with an on-board navigation system of an autonomous vehicle or physically connected to the vehicle 101 for serving as a navigation system. Also, the UEs 105 and/or vehicles 101 may be configured to access the communications network 123 by way of any known or still developing communication protocols. Via this communications network 123, the UEs 105 and/or vehicles 101 may transmit sensor data collected from IMU or equivalent sensors for facilitating vehicle speed calculations.

The UEs 105 and/or vehicles 101 may be configured with multiple sensors of different types for acquiring and/or generating sensor data according to the embodiments described herein. For example, sensors may be used as GPS or other positioning receivers for interacting with one or more location satellites to determine and track the current speed, position and location of a vehicle travelling along a roadway. In addition, the sensors may gather IMU data, NFC data, Bluetooth data, acoustic data, barometric data, tilt data (e.g., a degree of incline or decline of the vehicle during travel), motion data, light data, sound data, image data, weather data, temporal data and other data associated with the vehicle and/or UEs 105 thereof. Still further, the sensors may detect local or transient network and/or wireless signals, such as those transmitted by nearby devices during navigation of a vehicle along a roadway. This may include, for example, network routers configured within a premise (e.g., home or business), another UE 105 or vehicle 101 or a communicable traffic system (e.g., traffic lights, traffic cameras, traffic signals, digital signage).

By way of example, the speed module 117 and/or speed platform 119 may be implemented as a cloud-based service, hosted solution or the like for performing the above described functions. Alternatively, the speed module 117 and/or speed platform 119 may be directly integrated for processing data generated and/or provided by the service platform 125, one or more services 127, and/or content providers 129. Per this integration, the speed platform 119 may perform client-side state computation of vehicle speed data.

By way of example, the communications network 123 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

A UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that a UE 105 can support any type of interface to the user (such as “wearable” circuitry, etc.).

By way of example, the UE 105s, the speed module 117/speed platform 119, the service platform 125, and the content providers 129 communicate with each other and other components of the communications network 123 using well known, new or still developing protocols. In this context, a protocol includes a set of rules defining how the network nodes within the communications network 123 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

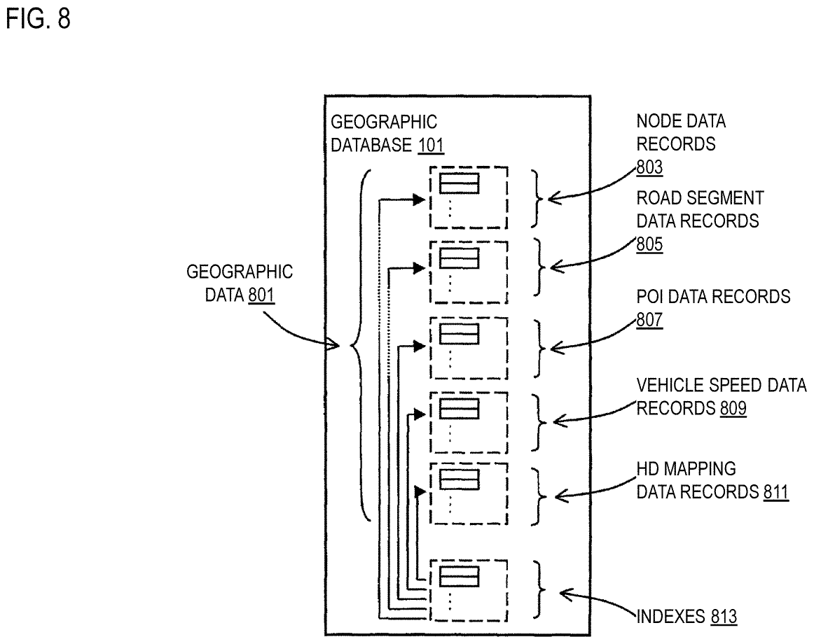

FIG. 8 is a diagram of a geographic database 131 that can be used in combination with speed data to provide location-based services, according to one embodiment. In one embodiment, the geographic database 131 includes geographic data 801 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 801. In one embodiment, the geographic database 131 include high definition (HD) mapping data that provide centimeter-level or better accuracy of map features. For example, the geographic database 131 can be based on Light Detection and Ranging (LiDAR) or equivalent technology to collect billions of 3D points and model road surfaces and other map features down to the number lanes and their widths. In one embodiment, the HD mapping data (e.g., HD data records 811) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 131.

“Node”—A point that terminates a link.

“Line segment”—A straight line connecting two points.

“Link” (or “edge”) —A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 131 follows certain conventions. For example, links do not cross themselves and do not cross each other except at a node. Also, there are no duplicated shape points, nodes, or links. Two links that connect each other have a common node. In the geographic database 131, overlapping geographic features are represented by overlapping polygons. When polygons overlap, the boundary of one polygon crosses the boundary of the other polygon. In the geographic database 131, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 131 includes node data records 803, road segment or link data records 805, POI data records 807, vehicle speed data records 809, HD mapping data records 811, and indexes 813, for example. More, fewer or different data records can be provided. In one embodiment, additional data records (not shown) can include cartographic (“carto”) data records, routing data, and maneuver data. In one embodiment, the indexes 813 may improve the speed of data retrieval operations in the geographic database 131. In one embodiment, the indexes 813 may be used to quickly locate data without having to search every row in the geographic database 131 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points corresponding to the respective links or segments of the road segment data records 805. The road link data records 805 and the node data records 803 represent a road network, such as used by vehicles, cars, and/or other entities. Alternatively, the geographic database 131 can contain path segment and node data records or other data that represent pedestrian paths or areas in addition to or instead of the vehicle road record data, for example. In one embodiment, the nodes and links can make up the base map and that base map can be associated with an HD layer including more detailed information, like lane level details for each road segment or link and how those lanes connect via intersections. Furthermore, another layer may also be provided, such as an HD live map, where road objects are provided in detail in regard to positioning, which can be used for localization. The HD layers can be arranged in a tile format.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 131 can include data about the POIs and their respective locations in the POI data records 807. The geographic database 131 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city).

In one embodiment, the geographic database 131 can also include vehicle speed data records 809 for storing speed data determined from IMU sensor data 103 according to the embodiments described herein. The vehicle speed data records 809 can also store related data including but not limited to sensor data 103, magnetic/vibrational signal data, spectrograms, determine rotational frequencies, and/or any other data used or generated according to the embodiments described herein. By way of example, the vehicle speed data records 809 can be associated with one or more of the node records 803, road segment records 805, and/or POI data records 807 to associate the determined vehicle speed data with specific geographic areas or features.

In one embodiment, as discussed above, the HD mapping data records 811 model road surfaces and other map features to centimeter-level or better accuracy (e.g., including centimeter-level accuracy for ground truth objects used for visual odometry based on polyline homogeneity according to the embodiments described herein). The HD mapping data records 811 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 811 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 811 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 811.

In one embodiment, the HD mapping data records 811 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like. The HD mapping data records may be provided as a separate map layer.

In one embodiment, the geographic database 131 can be maintained by the content provider 129 in association with the services platform 117 (e.g., a map developer). The map developer can collect geographic data to generate and enhance the geographic database 131. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 131 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. Other formats including tile structures for different map layers may be used for different delivery techniques. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by a vehicle 101 and/or UE 105. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for determining vehicle speed based on IMU sensor data 103 may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

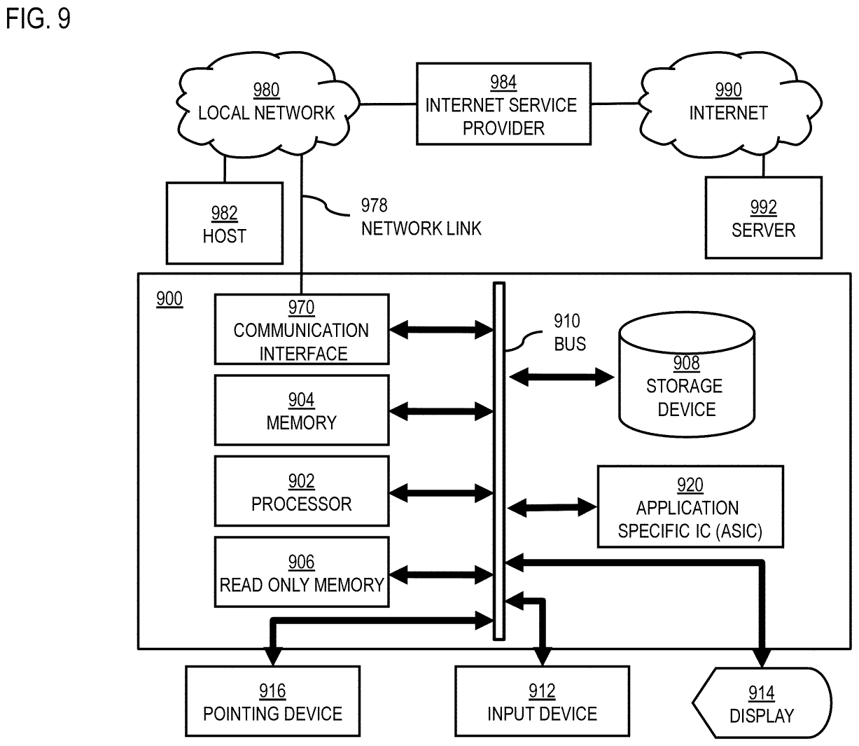

FIG. 9 illustrates a computer system 900 upon which an embodiment of the invention may be implemented. Computer system 900 is programmed (e.g., via computer program code or instructions) to determine vehicle speed based on IMU sensor data 103 as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to determining vehicle speed based on IMU sensor data 103. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for determining vehicle speed based on IMU sensor data 103. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for determining vehicle speed based on IMU sensor data 103, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 123 for determining vehicle speed based on IMU sensor data 103.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system can be deployed in various configurations within other computer systems, e.g., host 982 and server 992.

FIG. 10 illustrates a chip set 1000 upon which an embodiment of the invention may be implemented. Chip set 1000 is programmed to determine vehicle speed based on IMU sensor data 103 as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to determine vehicle speed based on IMU sensor data 103. The memory 1005 also stores the data associated with or generated by the execution of the inventive steps.

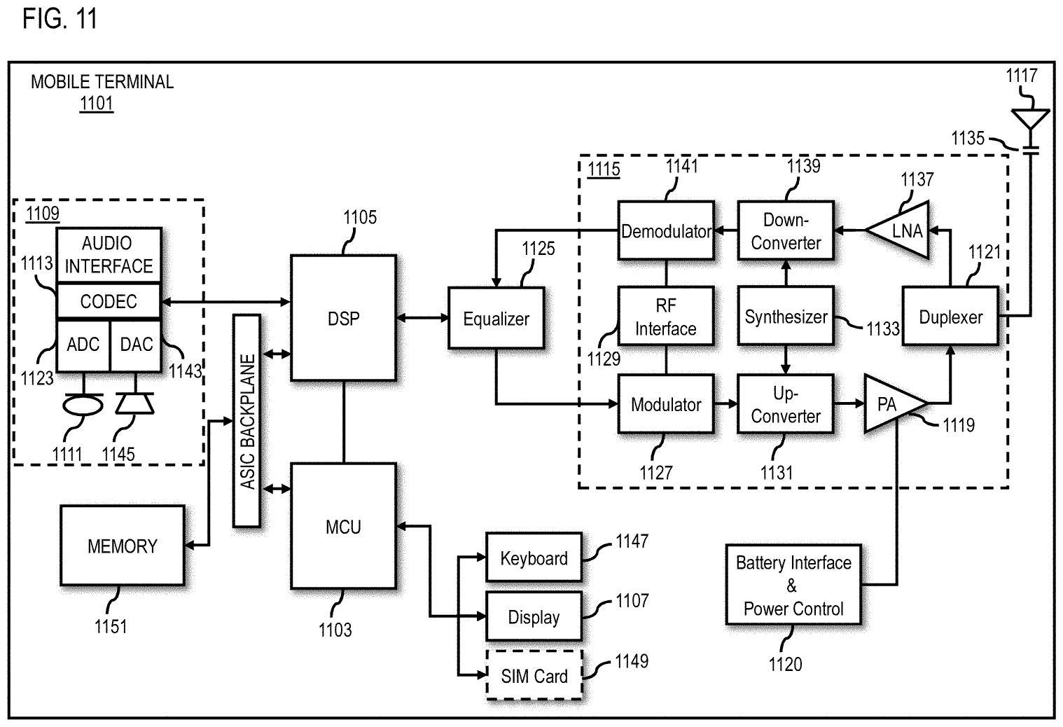

FIG. 11 is a diagram of exemplary components of a mobile terminal (e.g., UE 105) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to determine vehicle speed based on IMU sensor data 103. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining, by a processor, sensor data from a magnetometer, an accelerometer, or a combination thereof associated with a vehicle;
processing, by the processor, the sensor data to determine a rotational frequency of at least one tire of the vehicle;
calculating, by the processor, a speed of the vehicle based on the rotational frequency; and
providing, by the processor, the speed as an output.

2. The method of claim 1, further comprising:
determining a diameter of the at least one tire,
wherein the speed is calculated further based on the diameter.

3. The method of claim 1, further comprising:
determining a magnetic signal from the sensor data from the magnetometer,
wherein the rotational frequency is determined based on the magnetic signal.

4. The method of claim 3, wherein the magnetic signal represents one or more changes in a magnetic field.

5. The method of claim 3, further comprising:
processing the magnetic signal to determine a direction of the magnetic signal associated with the at least one tire,
wherein the rotational frequency is determined further based on a portion of the magnetic signal associated with said direction.

6. The method of claim 3, further comprising:
processing the magnetic signal to determine total magnetic energy data,
wherein the rotational frequency is determined further based on the total magnetic energy data.

7. The method of claim 1, further comprising:
determining a vibrational signal from the sensor data of the accelerometer,
wherein the rotational frequency is determined based on the vibrational signal.

8. The method of claim 7, further comprising:
generating a power spectrum of the vibrational signal; and
identifying one or more peaks of the power spectrum,
wherein the rotational frequency is determined based on the one or more peaks.

9. The method of claim 1, further comprising:
determining a background magnetic signal in the vehicle,
wherein in the processing of the sensor data is further based on processing the background magnetic signal.

10. The method of claim 1, wherein the processing of the sensor data includes at least one of:
applying at least one velocity limit;
identifying a fundamental frequency, a harmonic frequency, or a combination thereof;
filtering out the harmonic frequency;
using acceleration information from the accelerometer to estimate an expected frequency shift between two measurement windows; and
performing a ridge line detection in a spectrogram.

11. The method of claim 1, wherein the magnetometer, the accelerometer, or a combination thereof are one or more sensors of a mobile device associated with the vehicle.

12. The method of claim 1, wherein the magnetometer, the accelerometer, or a combination thereof are part of an inertial measurement unit.

13. An apparatus comprising:
at least one processor; and
at least one memory including computer program code for one or more programs,
the at least one memory and the computer program code configured to, with the at least one processor, cause the apparatus to perform at least the following,
determine sensor data from a magnetometer, an accelerometer, or a combination thereof associated with a vehicle;
process the sensor data to determine a rotational frequency of at least one tire of the vehicle;
calculate a diameter of the at least one tire or wheel of the vehicle based on the rotational frequency; and
provide the diameter as an output.

14. The apparatus of claim 13, wherein the apparatus is further caused to:
determine a type of the vehicle based on the diameter.

15. The apparatus of claim 13, wherein the apparatus is further caused to:
determine a magnetic signal from the sensor data from the magnetometer,
wherein the rotational frequency is determined based on the magnetic signal.

16. The apparatus of claim 13, wherein the apparatus is further caused to:
determine a vibrational signal from the sensor data of the accelerometer,
wherein the rotational frequency is determined based on the vibrational signal.

17. A non-transitory computer-readable storage medium carrying one or more sequences of one or more instructions which, when executed by one or more processors, cause an apparatus to perform:
determining sensor data from a magnetometer, an accelerometer, or a combination thereof associated with a vehicle;
processing the sensor data to determine a rotational frequency of at least one tire of the vehicle;
calculating a safety condition, a maintenance condition, or a combination thereof of the vehicle based on the rotational frequency; and
providing the safety condition, the maintenance condition, or a combination thereof as an output.

18. The non-transitory computer-readable storage medium of claim 1, wherein the safety condition, the maintenance condition, or a combination thereof relates to a wheel balancing, a low air pressure, a vehicle anomaly, or a combination thereof.

19. The me non-transitory computer-readable storage medium of claim 1, wherein the apparatus is caused to further perform:
determining a magnetic signal from the sensor data from the magnetometer,
wherein the rotational frequency is determined based on the magnetic signal.

20. The non-transitory computer-readable storage medium of claim 1, wherein the apparatus is caused to further perform:
determining a vibrational signal from the sensor data of the accelerometer,
wherein the rotational frequency is determined based on the vibrational signal.
